(19) United States
(12) Patent Application Publication
(10) Pub. No.: US 2025/0318981 A1
(43) Pub. Date: Oct. 16, 2025

(54) MASSAGER

(71) Applicants: Junpeng Wu, Shenzhen (CN); DONGGUAN MIMAO ELECTRONIC TECHNOLOGY CO., LTD., Dongguan (CN); Shenzhen Zhonghongtian Technology Co., Ltd., Shenzhen (CN)

(72) Inventor: Qinling Wang, Dongguan (CN)

(21) Appl. No.: 19/243,769

(22) Filed: Jun. 20, 2025

Related U.S. Application Data
(63) Continuation-in-part of application No. 18/977,984, filed on Dec. 12, 2024.
Application No. 18/977,984 is a continuation-in-part of application No. 18/644,172, filed on Apr. 24, 2024, now Pat. No. 12,178,773.

(30) Foreign Application Priority Data
Apr. 15, 2024 (CN) 202420778432.4
May 12, 2025 (CN) 202520932802.X

(51) Int. Cl. A61H 7/00; A61H 23/02

(52) U.S. Cl. CPC A61H 7/005; A61H 23/0254; A61H 2201/0192; A61H 2201/1207; A61H 2201/14; A61H 2201/1664; A61H 2201/1676; A61H 2201/5002

(57) ABSTRACT

A massager includes a main body, a mounting portion, a first massage assembly, and a drive mechanism. The main body defines an accommodation cavity. The mounting portion extends outward from the main body. The first massage assembly includes a first massage member and a second massage member. The first massage member is mounted on the mounting portion and protrudes from the mounting portion. The second massage member is mounted on the mounting portion and protrudes from the mounting portion. The drive mechanism is at least partially mounted in the accommodation cavity. The drive mechanism is drivingly connected to at least one of the first massage member and the second massage member and drives at least one of the first massage member and the second massage member to swing toward or away from the other of the first massage member and the second massage member.

### CROSS-REFERENCE TO RELATED APPLICATIONS

The present application is a continuation-in-part application of U.S. patent application Ser. No. 18/977,984, filed on Dec. 12, 2024, which is a continuation-in-part application of U.S. patent application Ser. No. 18/644,172, filed on Apr. 24, 2024. The present application further claims the priority of Chinese patent application Nos. 202420778432.4, filed on Apr. 15, 2024 and 202520932802.X, filed on May 12, 2025, the entire contents of which are hereby incorporated by reference.

### FIELD

The present disclosure relates to the field of massage devices, and particularly to a massager.

### BACKGROUND

As a health care device, massagers have been developed in various shapes, sizes, and functions to provide massage and/or stimulation to different parts of the human body. However, in the related art, some massagers with cavities in massage structures can create negative pressure adsorption on the skin during use, potentially causing damage to body parts and resulting in a poor user experience.

### SUMMARY

The present disclosure provides a massager. A massager includes a main body, a mounting portion, a first massage assembly, and a drive mechanism. The main body defines an accommodation cavity. The mounting portion extends outward from a side of the main body. The first massage assembly includes a first massage member and a second massage member spaced apart from the first massage member. The first massage member is mounted on the mounting portion and protrudes outward from the mounting portion. The second massage member is mounted on the mounting portion and protrudes outward from the mounting portion. The drive mechanism is at least partially mounted in the accommodation cavity of the main body. The drive mechanism is drivingly connected to at least one of the first massage member and the second massage member and is configured to drive the at least one of the first massage member and the second massage member to swing toward or away from the other of the first massage member and the second massage member.

### BRIEF DESCRIPTION OF THE DRAWINGS

To provide a clearer illustration of the technical solutions in the embodiments of the present disclosure or in the related art, a brief introduction will be given to the drawings used in the description of the embodiments or the related art. It is obvious that the drawings described below are merely some embodiments of the present disclosure, and for those skilled in the art, other drawings can be obtained based on these drawings without creative efforts.

FIG. 1 is a schematic view of an overall structure of a massager according to a first embodiment of the present disclosure.

FIG. 2 is an exploded view of a soft rubber shell and a main body of the massager according to the first embodiment of the present disclosure.

FIG. 3 is a cross-sectional view of the overall structure of the massager according to the first embodiment of the present disclosure.

FIG. 4 is an exploded view of the massager according to the first embodiment of the present disclosure.

FIG. 5 is a side view of an internal structure of the main body according to the first embodiment of the present disclosure.

FIG. 6 is a schematic view of the overall structure of the massager according to a second embodiment of the present disclosure.

FIG. 7 is a three-dimensional view of an internal structure of the massager according to the second embodiment and a sixth embodiment of the present disclosure.

FIG. 8 is a side view of the internal structure of the massager according to the second embodiment and the sixth embodiment of the present disclosure.

FIG. 9 is an exploded view of a drive mechanism according to the second embodiment of the present disclosure.

FIG. 10 is a schematic view of the overall structure of the massager according to a third embodiment of the present disclosure.

FIG. 11 is an exploded view of the massager according to the third embodiment of the present disclosure.

FIG. 12 is a cross-sectional view of the overall structure of the massager according to the third embodiment of the present disclosure.

FIG. 13 a side view of the internal structure of the main body according to a fourth embodiment of the present disclosure.

FIG. 14 is a side view of the internal structure of the main body according to a fifth embodiment of the present disclosure.

FIG. 15 is a side view of the internal structure of the main body according to a seventh embodiment of the present disclosure.

FIG. 16 is a side view of the internal structure of the main body according to an eighth embodiment of the present disclosure.

### REFERENCE NUMERALS IN THE DRAWINGS

1—main body; 10—accommodation cavity; 1000—fifth guide post; 11—first half—shell; 12—second half—shell; 13—handheld portion;
2—mounting portion; 20—mounting cavity;
3—first massage assembly; 31—first massage member; 310—first clamping end; 32—second massage member; 320—second clamping end; 33—massage connecting rod; 3300—first guide hole;
4—drive mechanism; 40—drive assembly; 400—drive screw; 401—guide tube; 4010—guide recess; 402—first drive motor; 403—second drive motor; 4030—eccentric protrusion;
41—first transmission assembly; 410—transmission member; 4100—transmission portion; 4101—transmission pin; 4102—second guide post; 4103—guide post; 4104—guide protrusion; 4105—reversing tube; 4106—fifth guide hole; 4107—transmission rod; 4108—eccentric rod; 4109—swing rod; 4110—insertion rod; 4412—slider; 4120—transmission groove; 42—second transmission assembly; 420—rotation center; 421—first link rod; 4210—first guide post; 422—second link rod; 423—third link rod; 4231—guide groove; 4230—second guide hole; 43—battery; 44—control board;
5—second massage assembly; 50—massage inner shell; 51—connecting member; 510—connecting end; 511—guide hole; 512—connecting shaft sleeve;
6—soft rubber shell;
7—vibration member.

### DETAILED DESCRIPTION

Unless otherwise defined, all technical and scientific terms used herein have the same meaning as commonly understood by those skilled in the art to which the present disclosure belongs. The terms used in the description of the present disclosure herein are intended for describing particular embodiments only and are not intended to limit the present disclosure. In the description, claims, and the above drawings of the present disclosure, the terms “including” and “having”, as well as their variants, are intended to convey a non-exclusive inclusion. The terms “first”, “second”, etc., as used herein, are intended to distinguish between different objects, rather than to describe a particular order.

Reference to “embodiments” herein implies that a particular feature, structure, or characteristic described in conjunction with an embodiment may be included in at least one embodiment of the present disclosure. The appearance of the phrase at various places in the specification does not necessarily refer to the same embodiment, nor is it a separate or an alternative embodiment that is mutually exclusive of other embodiments. One skilled in the art would explicitly and implicitly understand that the embodiments described herein can be combined with other embodiments.

In order to enable those skilled in the art to better understand the technical solutions of the present disclosure, the technical solutions in the embodiments of the present disclosure will be clearly and completely described below with reference to the accompanying drawings.

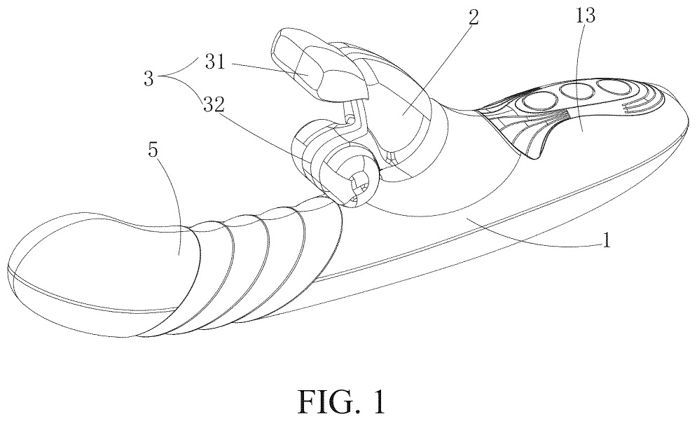

Referring to FIGS. 1-16, the present disclosure provides a massager. The massager includes a main body 1, a mounting portion 2, a first massage assembly 3, and a drive mechanism 4. An interior of the main body 1 defines an accommodation cavity 10. The mounting portion 2 extends outward from one side of the main body 1. Specifically, the main body 1 is generally in a shape of a long rod with an arc-shaped outer wall. The mounting portion 2 extends radially from a front end of the main body 1. The first massage assembly 3 includes a first massage member 31 and a second massage member 32 which are spaced apart from each other. The first massage member 31 is mounted on the mounting portion 2 and protrudes outward from the mounting portion 2. The second massage member 32 is mounted on the mounting portion 2 and protrudes outward from the mounting portion 2, with the second massage member 32 being closer to the main body 1 than the first massage member 31. The drive mechanism 4 is at least partially mounted in the accommodation cavity 10 of the main body 1 and is drivingly connected to at least one of the first massage member 31 and the second massage member 32 to drive at least one of the first massage member 31 and the second massage member 32 to swing toward or away from the other of the first massage member 31 and the second massage member 32. In some embodiments, the drive mechanism 4 is simultaneously drivingly connected to the first massage member 31 and the second massage member 32 to drive the first massage member 31 and the second massage member 32 to swing toward or away from each other. In other embodiments, one of the first massage member 31 and the second massage member 32 may remain stationary while the other of the first massage member 31 and the second massage member 32 swings. In further embodiments, only one first massage member 31 or only one second massage member 32 may be arranged on the mounting portion 2 to achieve swinging of a single massage member.

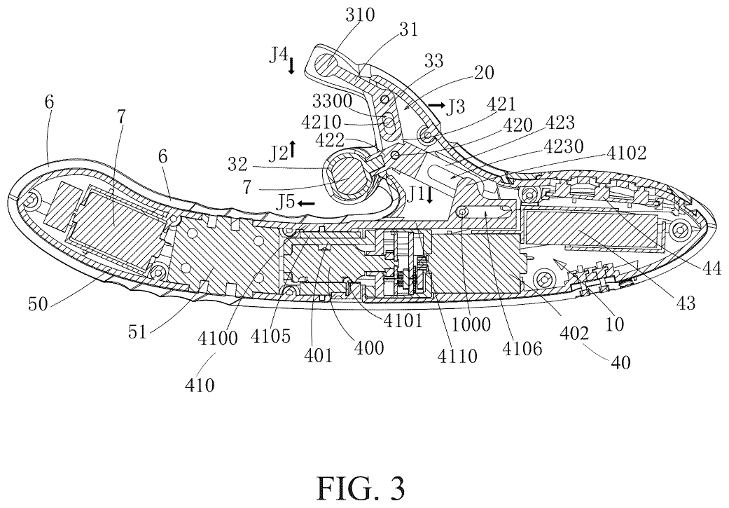

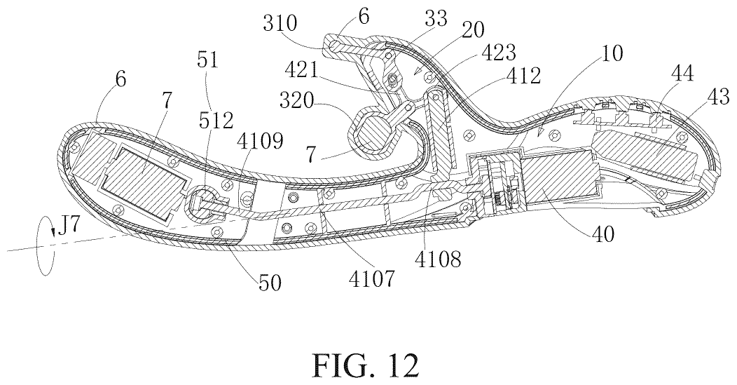

As shown in FIGS. 3 and 12, the first massage member 31 and the second massage member 32 approximately extend radially outward from the front end of the main body 1. That is, one end of the first massage member 31 is connected to the mounting portion 2, and the other end of the first massage member 31 extends away from a face of the mounting portion 2. Similarly, one end of the second massage member 32 is connected to the mounting portion 2, and the other end of the second massage member 32 extends away from the face of the mounting portion 2. The face of the mounting portion 2, the first massage member 31, and the second massage member 32 cooperatively form an open clamping space with openings on both sides, with a cross-section roughly U-shaped. In this way, when the first massage member 31 and the second massage member 32 move toward or away from each other under an action of the drive mechanism 4, no cavity is formed between the first massage member 31 and the second massage member 32, ensuring that the first massage member 31 and the second massage member 32 do not create negative pressure adsorption on a body part during clamping massage, thereby improving user experience.

To enhance comfort, a soft rubber shell 6 may sleeve a periphery of the first massage member 31 and the second massage member 32. In some embodiments, as shown in FIGS. 3 and 12, the soft rubber shell 6 may completely cover the first massage member 31, the second massage member 32, the mounting portion 2, and the main body 1, making an overall structure of the massager more stable. In particular, a thickness of the soft rubber shell 6 at the first massage member 31 and the second massage member 32 may be appropriately increased to improve comfort during clamping massage.

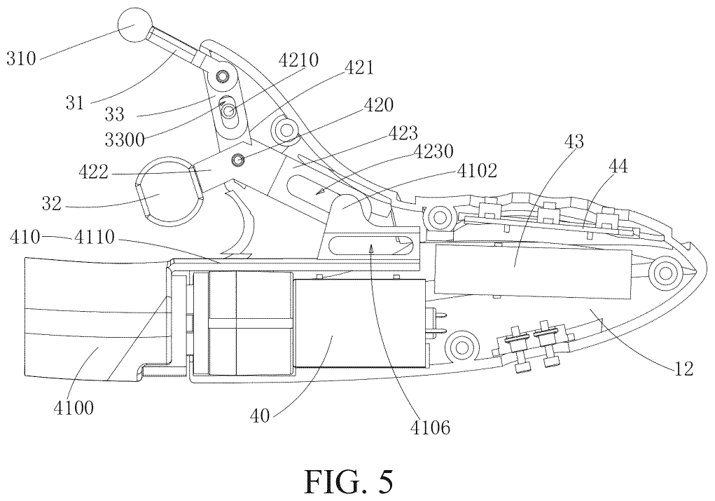

As shown in FIGS. 3, 5, and 12, in some embodiments, a maximum distance between the first massage member 31 and the face of the mounting portion 2 is greater than a maximum distance between the second massage member 32 and the face of the mounting portion 2. That is, a length by which the first massage member 31 protrudes from the face of the mounting portion 2 is greater than a length by which the second massage member 32 protrudes from the face of the mounting portion 2. As shown in FIG. 5, the first massage member 31 is farther from the main body 1 than the second massage member 32. A side of the first massage member 31 facing the second massage member 32 forms a contact face. The longer first massage member 31 provides a larger contact area, thereby increasing the contact area of the first massage member 31 with human body and improving comfort. Additionally, a length of the first massage member 31 is different from a length of the second massage member 32, allowing the first massage member 31 and the second massage member 32 to contact different parts of the body. For example, the second massage member 32 which is shorter can press against a side skin of a body part, while the contact face of the first massage member 31 which is longer contacts with a top skin of the body part. Movement of the first massage member 31 and the second massage member 32 toward or away from each other achieves a clamping and pinching massage effect, stimulating multiple parts of the body simultaneously.

As shown in FIGS. 3 and 12, in some embodiments, an end of the first massage member 31 is configured as a first clamping end 310, and an end of the second massage member 32 is configured as a second clamping end 320. A radial dimension of the first clamping end 310 is smaller than a radial dimension of the second clamping end 320. Specifically, a body of the first massage member 31 is generally trapezoidal and is arranged in a plate structure. An end of the body of the first massage member 31 with a shorter side is connected to the mounting portion 2 and an end of the body of the first massage member 31 with a longer side is configured as the first clamping end 310. The first clamping end 310 is roughly cylindrical. A diameter of the first clamping end 310 is slightly larger than a thickness of the body of the first massage member 31. After the entire first massage member 31 is covered by the soft rubber shell 6, an outer wall corresponding to the first massage member 31 facing the second massage member 32 has an arc-shaped contact face for transition. A body of the second massage member 32 is rod-shaped. An end of the body of the second massage member 32 away from the mounting portion 2 is configured as the second clamping end 320, which is generally elliptical cylindrical. A diameter of the second clamping end 320 is larger, thus creating a support face that contacts the body part, on a side wall of the second clamping end 320 spaced away from the mounting portion 2. After the entire second massage member 32 is covered by the soft rubber shell 6, the support face provides support and force to the body part. In some embodiments, an interior of the second clamping end 320 with a larger diameter may be hollow, and a vibration member 7 may be mounted in the interior of the second clamping end 320, giving the second massage member 32 a vibration massage function.

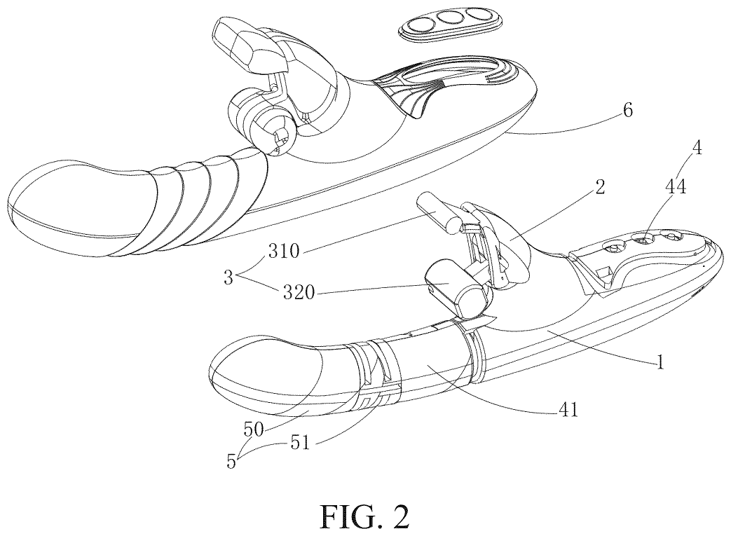

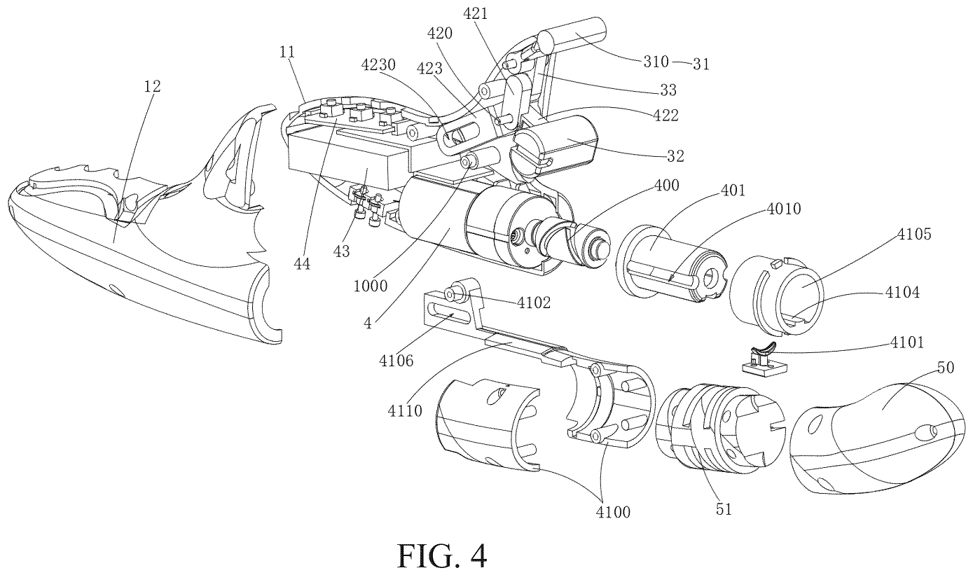

As shown in FIGS. 3 and 12, in some embodiments, an mounting cavity 20 is formed in the mounting portion 2 and is communicated to the accommodation cavity 10. The first massage assembly 3 includes a massage connecting rod 33. The massage connecting rod 33 is fixedly connected to at least one of the first massage member 31 and the second massage member 32. For example, the massage connecting rod 33 is fixedly connected to the first massage member 31. A connection point between the first massage member 31 and the massage connecting rod 33 is hinged to the mounting portion 2, and the massage connecting rod 33 is arranged in the mounting cavity 20 and is drivingly connected to the drive mechanism 4. Specifically, the mounting portion 2 and the main body 1 are integrally formed, including a first half-shell 11 and a second half-shell 12. The first half-shell 11 and the second half-shell 12 are snapped together to form the main body 1 with a shape of a rod and the mounting portion 2 radially protruding from the main body 1, with the mounting cavity 20 communicated to the accommodation cavity 10. The separable design of the first half-shell 11 and the second half-shell 12 facilitates mounting of the first massage assembly 3 and the drive mechanism 4. A handheld portion 13 is integrally arranged at a rear end of the main body 1 away from the mounting portion 2, providing a grip for the user, facilitating the user's use of the massager. As shown in FIGS. 2 and 4, an opening is defined in a side wall of a front end of the mounting portion 2 and is communicated to the mounting cavity 20. When the massage connecting rod 33 is arranged in the mounting cavity 20, the first massage member 31 extends out of the mounting cavity 20 through the opening. To allow the first massage member 31 to swing toward or away from the second massage member 32 when the massage connecting rod 33 swings, an angle between the first massage member 31 and the massage connecting rod 33 is greater than 90 degrees, particularly 130 degrees. The drive mechanism 4 drives an end of the massage connecting rod 33 away from a hinge axis to swing toward the opening, causing the first clamping end 310 of the first massage member 31 to swing away from the second massage member 32. Conversely, the drive mechanism 4 drives the end of the massage connecting rod 33 away from the hinge axis to swing away from the opening, causing the first clamping end 310 to swing toward the second massage member 32, achieving a swinging motion of the first massage member 31 and the second massage member 32 toward or away from each other.

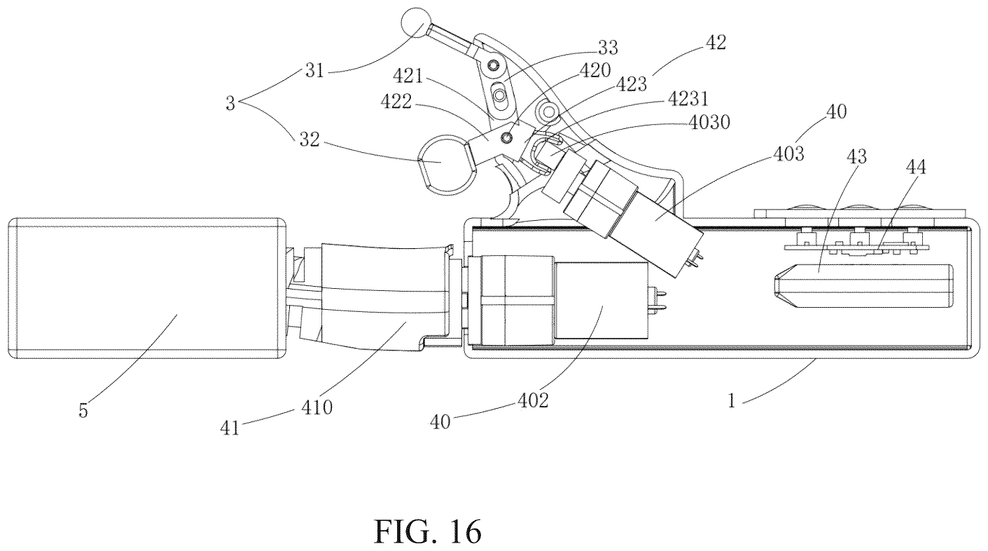

As shown in FIGS. 3, 4, 5, 7, 8, and 11, in some embodiments, the drive mechanism 4 includes a drive assembly 40, a first transmission assembly 41, and a second transmission assembly 42. The second transmission assembly 42 is movably mounted in the mounting cavity 20 and is configured to drive the massage connecting rod 33 and the second massage member 32. The first transmission assembly 41 is at least partially mounted in the accommodation cavity 10 and is drivingly connected to the second transmission assembly 42. The first transmission assembly 41 can slide or rotate relative to the main body 1. The drive assembly 40 is at least partially fixed in the accommodation cavity 10 and drives the first transmission assembly 41 to slide or rotate. The second transmission assembly 42 can move when driven by the sliding or rotating of the first transmission assembly 41. Alternatively, the drive assembly 40 is configured to separately drive the first transmission assembly 41 to move and to drive the second transmission assembly to move 42. Specifically, the accommodation cavity 10 can be divided along a length direction of the main body 1 into a front region, a middle region, and a rear region. The drive assembly 40 is fixed and mounted in the front region, while the first transmission assembly 41 is mounted in the front region and the middle region. Other components of the drive mechanism 4, such as a battery 43 and a control board 44 for the drive assembly 40 are mounted in the rear region. The battery 43 includes a charging port mounted on a shell wall of the main body 1. The charging port may be sealed with a plug when the battery 43 is not charged. The control board 44 is arranged with operation buttons, and an opening may be defined in the main body 1 corresponding to a top of the rear region of the accommodation cavity 10 to expose the operation buttons. Since the main body 1 is entirely covered by the soft rubber shell 6, the user can operate the operation buttons by pressing the soft rubber shell 6. Referring to FIGS. 3, 4, 5, 7, and 8, in some embodiments, in the massager, a single drive source is utilized to drive the first transmission assembly 41 and the second transmission assembly 42 to move. Specifically, the drive assembly 40 is configured to drive the first transmission assembly 41 to slide or rotate, which in turn drives the second transmission assembly 42 to move, thereby causing the first massage member 31 and the second massage member 32 to swing. In this configuration, the drive assembly 40 includes a first drive motor 402, and an output shaft of the first drive motor 402 can drive the first transmission assembly 41 to swing. Referring to FIG. 16, in other embodiments, the massager employs two independent drive sources to separately drive the first transmission assembly 41 and the second transmission assembly 42. Specifically, the drive assembly 40 includes a first drive motor 402 and a second drive motor 403. The first drive motor 402 is configured to drive the first transmission assembly 41 to move, thereby driving other massage structures of the massager to swing or rotate. The second drive motor drives the second transmission assembly 42 to move, causing the first massage member 31 and the second massage member 32 of the massager to swing. Additionally, an output shaft of each of the first drive motor 402 and the second drive motor 403 is arranged with a reduction gear set to increase torque at the output end.

As shown in FIGS. 3 and 5, in some embodiments, the second transmission assembly 42 includes a first link rod 421 and a second link rod 422 connected to the first link rod 421. An end of the first link rod 421 is connected to an end of the second link rod 422. A connection point between the first link rod 421 and the second link rod 422 is rotatably connected to an inner wall of the mounting portion 2 corresponding to the mounting cavity 20 to form a rotation center 420. An end of the first link rod 421 away from the rotation center 420 is arranged with a first guide post 4210. The massage connecting rod 33 defines a first guide hole 3300 extending along a length direction of the massage connecting rod 33, and the first guide post 4210 can slide along the first guide hole 3300. An end of the second link rod 422 away from the rotation center 420 is fixedly connected to the second massage member 32. The first transmission assembly 41 can drive the first link rod 421 and the second link rod 422 to swing around the rotation center 420, causing the first massage member 31 and the second massage member 32 to swing toward or away from each other. An angle is formed between the first link rod 421 and the second link rod 422, allowing an end of the first link rod 421 to connect to the massage connecting rod 33 and an end of the second link rod 422 to connect to the second massage member 32. Since the second massage member 32 is rigidly and coaxially connected to the second link rod 422, the second link rod 422 can swing about the rotation center 420, causing the second massage member 32 to swing in a same direction with the second link rod 422. When the first link rod 421 swings, under a cooperation of the first guide post 4210 and the first guide hole 3300, the massage connecting rod 33 can swing toward or away from the opening of the mounting portion 2, making the first massage member 31 swing in an opposite direction to the second massage member 32, achieving the swinging motion of the first massage member 31 and the second massage member 32 toward or away from each other.

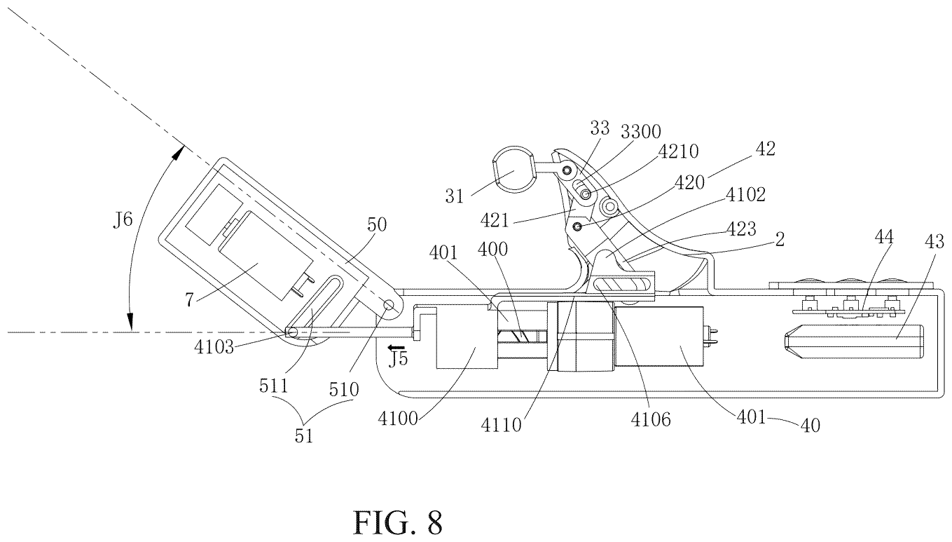

As shown in FIGS. 3 and 8, in some embodiments, the first transmission assembly 41 is slidably mounted in the accommodation cavity 10 and can slide back and forth along a length direction of the accommodation cavity 10. Based on this, the second transmission assembly 42 further includes a third link rod 423. An end of the third link rod 423 is close to the rotation center 420 and fixedly connected to at least one of the first link rod 421 and the second link rod 422. The third link rod 423 defines a second guide hole 4230 extending along a length direction of the third link rod 423. The first transmission assembly 41 includes a second guide post 4102 engaged in the second guide hole 4230. The second guide post 4102 can slide back and forth along a length direction of the second guide hole 4230, causing the first link rod 421 and the second link rod 422 to swing around the rotation center 420. Specifically, an angle between the length direction of the second guide hole 4230 and a sliding direction of the first transmission assembly 41 is less than 60 degrees. When the first transmission assembly 41 is in a first extreme position near the rear region of the accommodation cavity 10, the angle between the length direction of the second guide hole 4230 and the sliding direction of the first transmission assembly 41 is smallest, and a distance between the first clamping end 310 and the second clamping end 320 is largest. When the first transmission assembly 41 slides in a direction of arrow J5 to a second extreme position away from the rear region, the angle between the length direction of the second guide hole 4230 and the sliding direction of the first transmission assembly 41 is largest, and the distance between the first clamping end 310 and the second clamping end 320 is smallest. In other words, the back-and-forth sliding of the first transmission assembly 41 causes an end of the third link rod 423 away from the rotation center 420 to swing toward or away from the first transmission assembly 41. Based on this principle, the swinging motion of the first massage member 31 and the second massage member 32 toward or away from each other is as follows: as shown in FIG. 3, when the first transmission assembly 41 slides in the direction of arrow J5, the end of the third link rod 423 away from the rotation center 420 swings downward in a direction of arrow J1, the second link rod 422 swings upward in a direction of arrow J2, causing the second massage member 32 to swing upward. Meanwhile, the first guide post 4210 fixed to the first link rod 421 swings to the right in a direction of arrow J3, causing the first clamping end 310 to swing downward in a direction of arrow J4, achieving the swinging motion of the first massage member 31 and the second massage member 32 toward each other. Conversely, when the end of the third link rod 423 away from the rotation center 420 swings upward, the first massage member 31 and the second massage member 32 swing away from each other. It should be noted that in some embodiments, the massager may also achieve a single-sided swinging. For example, only the second massage member 32 and the second link rod 422 and the third link rod 423 which are configured to drive the second massage member 32 may be retained, while the first massage member 31 and the massage connecting rod 33 and the first link rod 421 which are configured to drive the first massage member 31 may be omitted. In this case, the first transmission assembly 41 can drive the third link rod 423 to swing up and down, thereby causing the second massage member 32 to swing up and down.

To expand massage functions of the massager, in some embodiments, the massager further includes a second massage assembly 5. The second massage assembly 5 is in a shape of a rod. The second massage assembly 5 is drivingly connected to the first transmission assembly 41 and arranged on one side of the main body 1. The first transmission assembly 41 is configured to drive the second massage assembly 5 to extend/retract or swing relative to the main body 1. A length of the second massage assembly 5 is significantly greater than each of a length of the first massage member 31 and a length of the second massage member 32. Specifically, the length of the second massage assembly 5 can be in a range of 5 cm-25 cm, while each of the length of the first massage member 31 and the length of the second massage member 32 can be in a range of 1 cm-4 cm. The second massage assembly 5 is primarily configured to insert into a specified part of the human body to perform contact massage on internal, non-exposed areas. Meanwhile, the first massage member 31 and the second massage member 32 provide contact massage on the external, exposed parts of the human body.

As shown in FIGS. 3, 4, 5, 8, 11, and 12, in some embodiments, the first transmission assembly 41 includes a transmission member 410. The transmission member 410 is slidably mounted in the accommodation cavity 10. One end of the transmission member 410 is configured to drive the second transmission assembly 42, specifically has a second guide post 4102 engaged in the second guide hole 4230. The other end of the transmission member 410 extends out of the accommodation cavity 10 and is connected to the second massage assembly 5. The transmission member 410 further includes a transmission portion 4100 drivingly connected to the drive assembly 40. The drive assembly 40 is configured to drive the transmission member 410 to slide back and forth, causing the second massage assembly 5 to extend/retract or swing relative to the main body 1. Specifically, an opening is defined at the front end of the main body 1 to communicate to the accommodation cavity 10. One end of the transmission portion 4100 is arranged with an insertion rod 4110 extending into the accommodation cavity 10. An end of the insertion rod 4110 is arranged with the second guide post 4102 to drive the second transmission assembly 42. The other end of the transmission portion 4100 is connected to the second massage assembly 5. The transmission portion 4100 is arranged in a tubular structure, allowing the transmission portion 4100 to sleeve a periphery of the output shaft of the drive assembly 40 and establish a drive connection with the drive assembly 40, enabling the drive assembly 40 to drive the transmission member 410 to slide back and forth along the length direction of the accommodation cavity 10, simultaneously driving the swinging motion of the first massage member 31 and the second massage member 32 toward or away from each other and the extending/retracting or swinging motion of the second massage assembly 5. It should be noted that in some embodiments, the soft rubber shell 6 further covers the second massage assembly 5 and the transmission portion 4100 outside the accommodation cavity 10, enhancing structural stability of the massager and comfort of the second massage assembly 5. Essentially, the soft rubber shell 6 fully encloses the main body 1, the mounting portion 2, the handheld portion 13, the first massage assembly 3, and the second massage assembly 5, improving comfort while providing waterproof sealing for the drive mechanism 4 internally arranged.

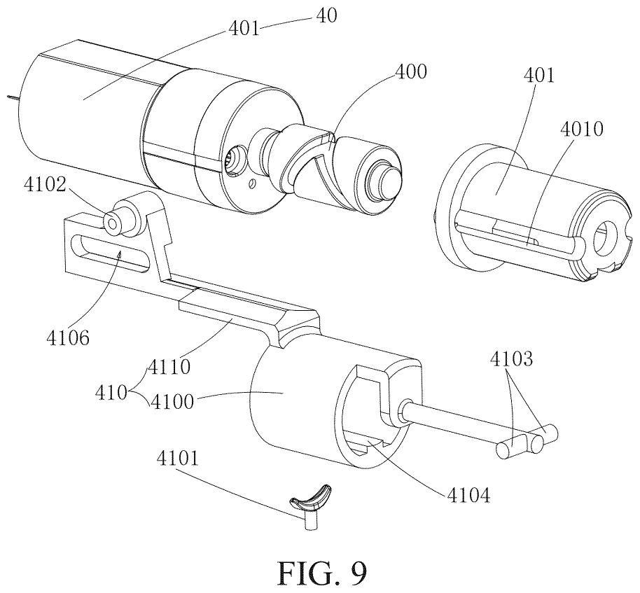

Referring to FIGS. 4 and 9, the drive assembly 40 includes a drive screw 400 and a guide tube 401. An end of the drive screw 400 is connected to the output shaft of the first drive motor 402 or connected to the speed reduction gear set mounted on the output shaft, such that the drive screw 400 can rotate. The guide tube 401 coaxially sleeves a periphery of the drive screw 400. At least one guide recess 4010 is defined in a tube wall of the guide tube 401, extending along an axial direction of the guide tube 401. A transmission portion 4100 arranged in a tubular structure coaxially sleeves the guide tube 401 and is slidable along a length direction of the guide recess 4010. The transmission portion 4100 is drivingly connected to the drive screw 400. For ease of assembly, the transmission portion 4100 includes a reversing tube 4105 which is separately arranged. The reversing tube 4105 coaxially sleeves an outer wall of the guide tube 401. An inner wall of the reversing tube 4105 is arranged with a guide protrusion 4104 engaged in the guide recess 4010. The guide protrusion 4104 is slidable along the length direction of the guide recess 4010 and serves to restrict rotation of the transmission member 410. Additionally, a transmission pin 4101 may be mounted at a location of the guide protrusion 4104. The transmission pin 4101 is drivingly connected to the drive screw 400. Specifically, an end of the transmission pin 4101 is positioned in a thread groove of the drive screw 400. As the drive screw 400 rotates, a side wall of the drive screw 400 corresponding to the thread groove drives the end of the transmission pin 4101 to slide in the length direction of the guide recess 4010, thereby causing the transmission portion 4100, and thus the transmission member 410, to slide. Alternately rotating the drive screw 400 clockwise and counterclockwise enables the transmission member 410 to slide back and forth, ultimately causing the first massage member 31 and the second massage member 32 to swing toward or away from each other through the second transmission assembly 42, and also causing the second massage assembly 5 to extend/retract or swing.

In some embodiments, to make an overall structure of the first transmission assembly 41 more compact, the reversing tube 4105 may be omitted. As shown in FIG. 9, the transmission portion 4100 in the tubular structure directly sleeves the guide tube 401, and the guide protrusion 4104 is directly formed on an inner wall of the transmission portion 4100 to be engaged in the guide recess 4010. Correspondingly, the transmission pin 4101 is fixed on the guide protrusion 4104, enabling the transmission pin 4101 to be drivingly connected to the drive screw 400.

Referring to FIGS. 3-4, in some embodiments, to improve stability of movement of the transmission member 410 in the main body 1, the transmission member 410 further defines a fifth guide hole 4106. Correspondingly, an inner wall of the main body 1 is arranged with a fifth guide post 1000. The fifth guide post 1000 is inserted into the fifth guide hole 4106. The fifth guide hole 4106 is an elongated waist-shaped hole. A length direction of the fifth guide hole 4106 is consistent with a sliding direction of the transmission member 410. A length of the fifth guide hole 4106 corresponds to a sliding stroke of the transmission member 410. That is, when the transmission member 410 slides to an extreme position in a direction, an end wall of the transmission member 410 corresponding to the fifth guide hole 4106 abuts against the fifth guide post 1000, thereby preventing further movement of the transmission member 410 in this direction.

Driven by the transmission member 410, the second massage assembly 5 may extend/retract or swing. A specific connection manner between the second massage assembly 5 and the transmission member 410 enables the second massage assembly 5 to perform various movements, such as extending/retracting or swinging motion, relative to the main body 1.

As an example, the second massage assembly 5 includes a massage inner shell 50 and a connecting member 51 fixedly connected to the massage inner shell 50. The connecting member 51 is also fixedly connected to the transmission member 410. A reciprocating sliding motion of the transmission member 410 drives the massage inner shell 50 to slide back and forth, causing the second massage assembly 5 to extend/retract relative to the main body 1. Referring to FIGS. 2, 3, and 4, the connecting member 51 is a cylindrical structure made of rigid plastic. A sliding movement of the transmission member 410 can be transmitted to the massage inner shell 50 via the connecting member 51, enabling synchronous sliding of the massage inner shell 50 with the transmission member 410 relative to the main body 1. The second massage assembly 5 is encased by the soft rubber shell 6. Due to inherent stretchable and contractible properties of the soft rubber shell 6, a portion of the soft rubber shell 6 encasing the massage inner shell 50 undergoes extension and contraction along with the movement of the inner shell 50. In addition, a plurality of deformation slots are formed in an outer wall of the connecting member 51, allowing the connecting member 51 to undergo slight deformation when subjected to radial external force. Thus, the second massage assembly 5 may appropriately bend along a radial direction of the second massage assembly 5.

Referring to FIG. 3, in some embodiments, the massager further includes at least one vibration member 7. The at least one vibration member 7 may be arranged in at least one of the first massage member 31, the second massage member 32, and the second massage assembly 5. For example, the number of the at least one vibration member 7 is two. One of the two vibration members 7 may be arranged in the second massage member 32, and the other of the two vibration members 7 may be arranged in the second massage assembly 5. For example, one of the two vibration members 7 may be mounted in the second clamping end 320 of the second massage member 32, and the other of the two vibration members 7 may be mounted in the massage inner shell 50 of the second massage assembly 5. By activating the two vibration members 7, the second massage member 32 and the second massage assembly 5 produce vibration or oscillation during use, thereby enhancing the massage and stimulation effect on the human body.

In summary, as illustrated in FIGS. 1 to 5, in a first embodiment of the present disclosure, the massager utilizes a single drive source, namely the first drive motor 402 of the drive assembly 40, to drive the first transmission assembly 41 to slide. The sliding motion of the first transmission assembly 41 drives, on one hand, the second transmission assembly 42 to rotate, causing the first massage member 31 and the second massage member 32 to swing toward or away from each other, thereby achieving the clamping and pinching massage effect on body parts. Additionally, the sliding motion simultaneously drives the second massage assembly 5 to extend/retract relative to the main body 1, allowing the second massage assembly 5 to perform extending/retracting motion after insertion into the human body, further stimulating internal areas and enhancing an overall massage effect of the massager.

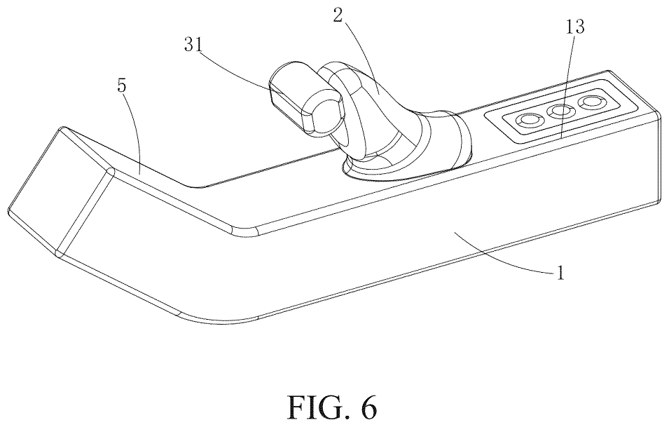

Referring to FIGS. 6-9, the massager of a second embodiment of the present disclosure is substantially the same as the massager of the aforementioned first embodiment, and the common features will not be repeated here. The main difference between the two lies in the second massage assembly 5 and first massage assembly 3. Specifically, distinctions regarding the first massage assembly 3 will be elaborated in the sixth embodiment. This section focuses on differences of the second massage assembly 5. Particularly, in this embodiment, the sliding of the transmission member 410 can also cause the second massage assembly 5 to swing. Specifically, the second massage assembly 5 includes a massage inner shell 50 and a connecting member 51 fixedly connected to the massage inner shell 50. The connecting member 51 includes a connecting end 510 and defines a guide hole 511. The connecting end 510 is pivotally connected to the main body 1. The transmission member 410 is arranged with a guide post 4103 engaged in the guide hole 511. The guide post 4103 can slide back and forth along a length direction of the guide hole 511. The reciprocating sliding of the transmission member 410 drives the massage inner shell 50 to slide back and forth around a rotation axis of the connecting end 510, causing the second massage assembly 5 to swing relative to the main body 1. Specifically, the connecting end 510 is a structure extending axially outward from a side wall of the massage inner shell 50, the guide hole 511 is a waist-shaped hole, and the length direction of the guide hole 511 is perpendicular to the sliding direction of the transmission member 410, such that when the transmission member 410 slides, the guide post 4103 pushes or pulls an inner wall of the connecting member 51 corresponding to the guide hole 511 during a sliding process in the guide hole 511, thereby causing the massage inner shell 50 to swing around the rotation axis of the connecting end 510. An overall movement process is as follows: referring to FIG. 8, when the transmission member 410 slides to the left in the direction of arrow J5, the guide post 4103 abuts against and pushes a left inner wall of the connecting member 51 corresponding to the guide hole 511, causing the massage inner shell 50 to swing upward in a direction of arrow J6; and conversely, the massage inner shell 50 is caused to swing downward, thereby allowing the second massage assembly 5 to swing up and down relative to the main body 1. Through the reciprocating sliding of the transmission member 410, the second massage assembly 5 is allowed to swing back and forth according to a predetermined trajectory, improving the massage stimulation effect of the second massage assembly 5 in the human body. It should further be noted that the massager according to the second embodiment may employ both the first massage member 31 and second massage member 32 which are configured to swing simultaneously as described in the first embodiment. Alternatively, the massager according to the second embodiment may employ both the first massage member 31 and second massage member 32, while only one of the first massage member 31 and second massage member 32 is configured to swing as described in the fourth and fifth embodiments.

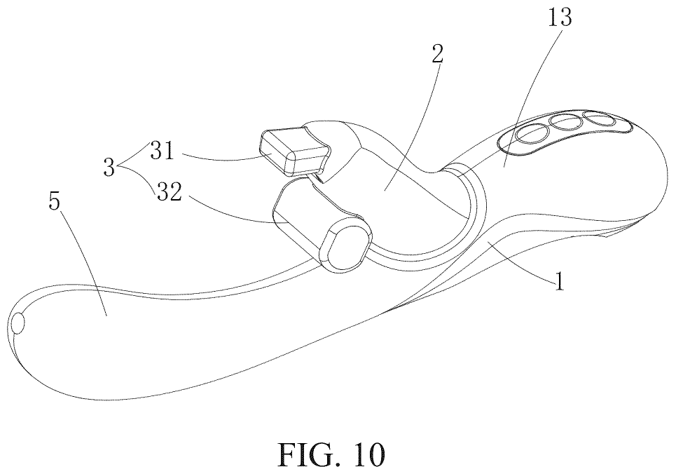

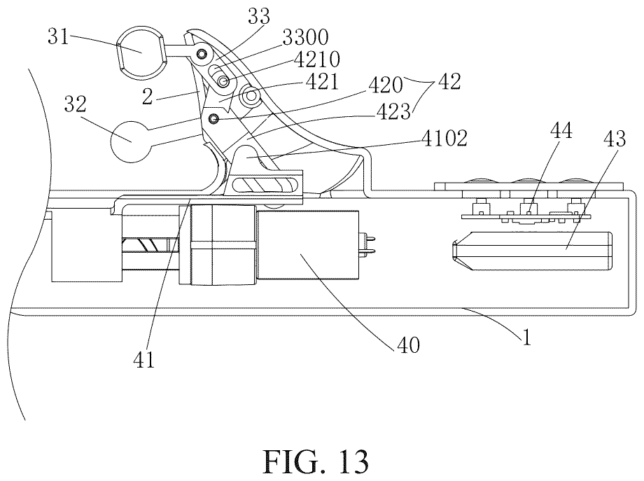

Referring to FIGS. 10-12, the massager of a third embodiment of the present disclosure is substantially the same as the massager of the aforementioned first embodiment, and the common features will not be repeated here. The main differences between the two lie in the first transmission assembly 41, the third link rod 423, and the second massage assembly 5 of the massager, that is, in this embodiment, the transmission member 410 can rotates to drive the third link rod 423 to swing up and down, and the rotation of the transmission member 410 can also cause the second massage assembly 5 to swing differently from the second embodiment. Specifically, the second massage assembly 5 includes a massage inner shell 50 and a connecting shaft sleeve 512 arranged on the massage inner shell 50. The first transmission assembly 41 includes a transmission rod 4107, a slider 412, and a swing rod 4109. The transmission rod 4107 is rotatably mounted in the accommodation cavity 10, one end of the transmission rod 4107 is fixedly connected to the output shaft of the first drive motor 402, and the other end of the transmission rod 4107 extends out of the accommodation cavity 10 and is fixedly connected to the swing rod 4109. The swing rod 4109 is rotatably connected to the second massage assembly 5. An axis of the swing rod 4109 intersects an axis of the transmission rod 4107, and the rotation of the transmission rod 4107 can cause the massage inner shell 50 to swing around the axis of the transmission rod 4107, the transmission rod 4107 and the swing rod 4109 are integrally formed as a one-piece structure, and the swing rod 4109 is a bent structure at an end of the transmission rod 4107, thereby making the axis of the swing rod 4109 intersect the axis of the transmission rod 4107. This arrangement allows the swing rod 4109 to swing circularly around the rotation axis of the transmission rod 4107 when the transmission rod 4107 rotates. Since an end of the swing rod 4109 is rotatably connected to the massage inner shell 50, the end of the swing rod 4109 drives the massage inner shell 50 to swing circularly, that is, the second massage assembly 5 generates circular swing, improving the massage effect of the second massage assembly 5 in the human body. In this embodiment, the transmission rod 4107 can be set to alternately rotate clockwise for one revolution and counterclockwise for one revolution, causing the second massage assembly 5 to generate reciprocating circular swing in the direction of arrow J7 shown in FIG. 13, such that the soft rubber shell 6 wrapping around the second massage assembly 5 will not be excessively rotated and deformed by twisting. It should further be noted that the massager according to the third embodiment may employ only one first massage member 31 which are configured to singly swing as described in the second, sixth, and the seventh embodiments. Alternatively, the massager according to the third embodiment may employ both the first massage member 31 and second massage member 32, while only one of the first massage member 31 and second massage member 32 is configured to swing as described in the fourth and fifth embodiments.

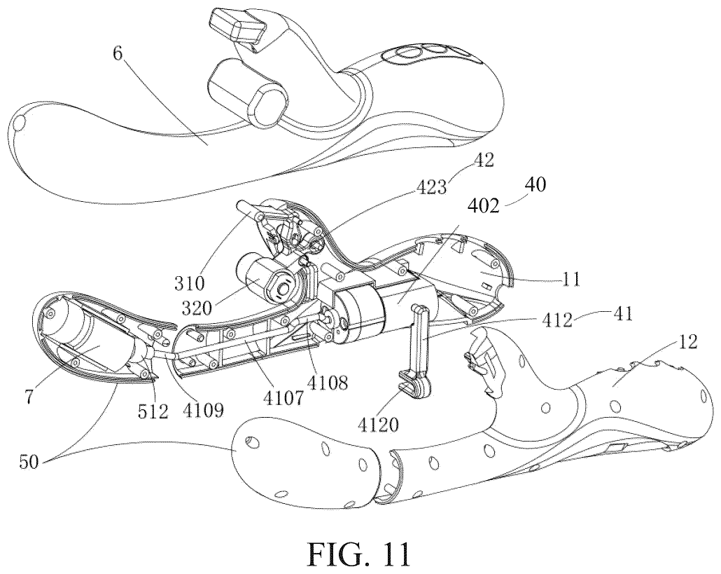

Referring to FIGS. 11 and 12, in this embodiment, the first transmission assembly 41 further includes a slider 412. An eccentric rod 4108 is fixed on the transmission rod 4107 and is arranged parallel and spaced apart from the transmission rod 4107. The slider 412 is slidably mounted in a shell of the main body 1, one end of the slider 412 is pivotally connected to the second transmission assembly 42, and the other end defines a transmission groove 4120, and the slider 412 is slidably connected to the eccentric rod 4108 through the transmission groove 4120. The rotation of the second transmission member 410 can drive the slider 412 to swing back and forth, thereby driving the second transmission assembly 42 to move. Specifically, the inner wall of the mounting portion 2 of the mounting cavity 20 defines a sliding groove for the slider 412 to slide in, and a length direction of the sliding groove is perpendicular to an axial direction of the transmission rod 4107, such that when the transmission rod 4107 rotates, the eccentric rod 4108 can drive the slider 412 to slide back and forth, and the one end of the slider 412 is pivotally connected to the end of the third link rod 423 of the second transmission assembly 42. A sliding direction of the slider 412 is consistent with an up and down swing direction of the third link rod 423, thereby driving the first link rod 421 and the second link rod 422 to complete a predetermined movement, causing the first massage member 31 and the second massage member 32 to swing toward or away from each other. In this embodiment, the eccentric rod 4108 is integrally formed with the transmission rod 4107 as a one-piece structure, and the eccentric rod 4108 is specifically a bent structure of the transmission rod 4107.

Referring to FIG. 13, the massager according to the fourth embodiment of the present disclosure is substantially identical to the massager of the aforementioned first embodiment, and the identical parts will not be repeated here. The main difference between the fourth embodiment and the first embodiment lies in that the first massage assembly 3 of the fourth embodiment includes the first massage member 31 and the second massage member 32. Only the first massage member 31 can swing. As shown in FIG. 13, the first massage member 31 can swing relative to the second massage member 32. The first massage member 31 is drivingly connected to the first link rod 421 of the second transmission assembly 42 through the massage connecting rod 33 and is drivingly connected to the first transmission assembly 41 through the third link rod 423. Since the second massage member 32 does not need to swing, the second link rod 422 can be omitted in this embodiment compared to the first embodiment, and the second massage member 32 can be directly fixed to an outer wall of the mounting portion 2, maintaining a spaced arrangement with the first massage member 31. It should also be noted that the first massage member 31 can be directly fixedly connected to an end of the first link rod 421 away from the rotation center 420, in which case the massage connecting rod 33 can be omitted, and in this configuration, the first massage member 31 can also be driven to swing.

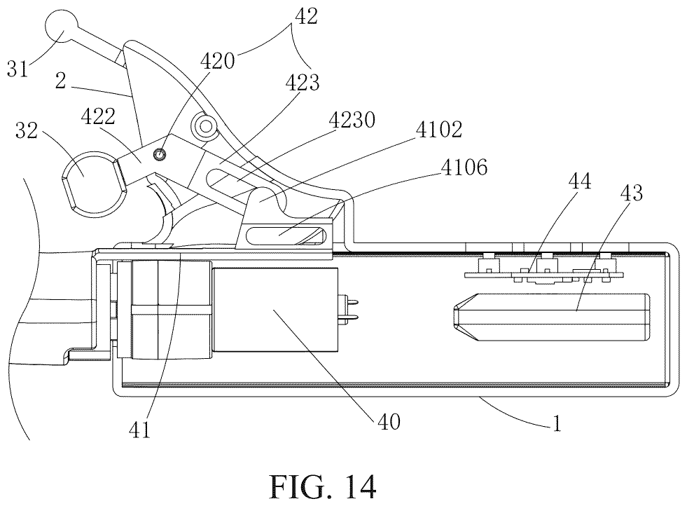

Referring to FIG. 14, the massager according to the fifth embodiment of the present disclosure is substantially identical to the massager of the aforementioned first embodiment, and the identical parts will not be repeated here. The main difference between them lies in that the first massage assembly 3 of this embodiment includes the first massage member 31 and the second massage member 32, and only the second massage member 32 can swing. As shown in FIG. 14, the second massage member 32 of this embodiment serves as the swingable massage member, meaning the second massage member 32 can swing relative to the first massage member 31. The second massage member 32 is fixedly connected to an end of the second link rod 422 away from the rotation center 420 and is drivingly connected to the first transmission assembly 41 through the third link rod 423. Since the first massage member 31 does not need to swing, in this embodiment, the first link rod 421 and the massage connecting rod 33 can be omitted, and the first massage member 31 is directly fixed to the outer wall of the mounting portion 2.

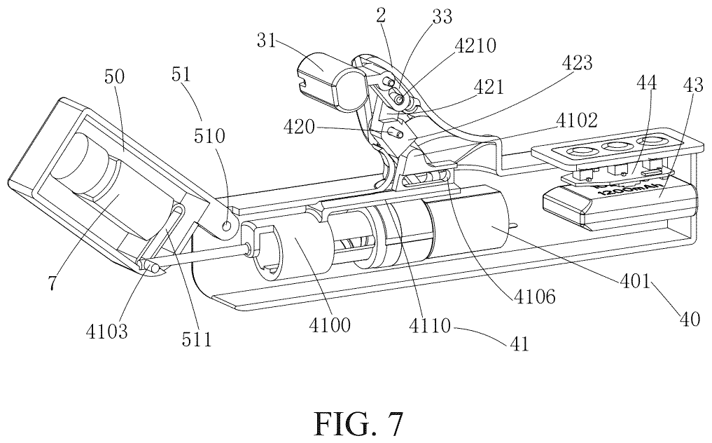

Referring to FIGS. 6, 7, and 8, the massager according to the sixth embodiment of the present disclosure is substantially identical to the massager of the aforementioned first embodiment, and the identical parts will not be repeated here. The main difference between the sixth embodiment and the first embodiment lies in the first massage assembly 3 and the second massage assembly 5. Specifically, this embodiment adopts the structure of the second massage assembly 5 as described in the second embodiment, while the focus of this embodiment is on the differences in the first massage assembly 3. Particularly, the first massage assembly 3 in this embodiment includes only one first massage member 31, meaning only one first massage member 31 is mounted on the mounting portion 2. Specifically, the first massage member 31 is arranged on the mounting portion 2 and protrudes outward from the mounting portion 2, with only one first massage member 31 arranged on the mounting portion 2. The drive mechanism 4 is configured to drive the first massage member 31 to swing toward or away from the main body 1. In this embodiment, the drive mechanism 4 shown in FIG. 7 is adopted. The drive mechanism 4 includes the drive assembly 40, the first transmission assembly 41, and the second transmission assembly 42. The drive assembly 40 and the first transmission assembly 41 may adopt corresponding structures described in the first, second, and third embodiments. The second transmission assembly 42 in this embodiment specifically has the following differences. The second transmission assembly 42 includes the first link rod 421 and the third link rod 423 connected to each other. A connection point of the first link rod 421 and the third link rod 423 is rotatably connected to the inner wall of the mounting portion 2 corresponding to the mounting cavity 20 to form the rotation center 420. The massager of this embodiment also includes the massage connecting rod 33 connecting the first massage member 31 and the first link rod 421. A driving manner between the massage connecting rod 33 and the first link rod 421, as well as a driving manner between the third link rod 423 and the first transmission assembly 42, adopts the driving manner described in the first embodiment. Since only one first massage member 31 is mounted on the mounting portion 2, the second transmission assembly 42 of this embodiment does not include the second link rod 422. It should also be noted that the first massage member 31 can also be directly fixedly connected to an end of the first link rod 421 away from the rotation center 420, and the swinging of the third link rod 423 can directly drive the end of the first link rod 421 away from the rotation center 420 to swing around the rotation center 420, thereby achieving the swinging of the first massage member 31. Additionally, a vibration member 7 may be mounted in the first massage member 31 of this embodiment, enabling the first massage member 31 to provide vibration massage.

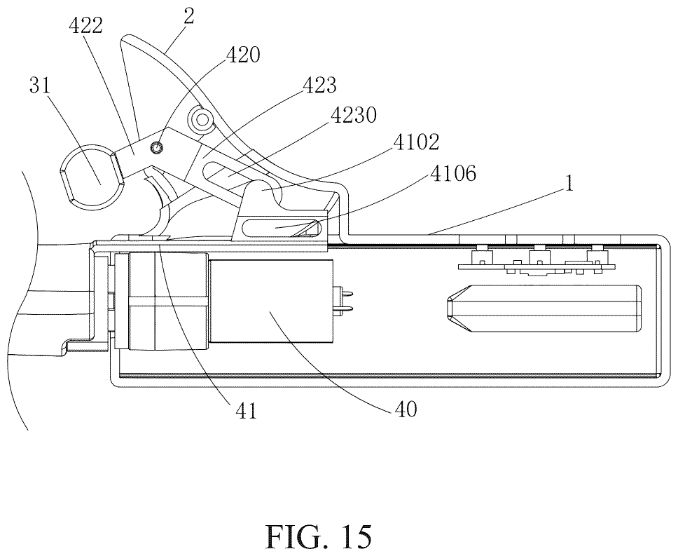

Referring to FIG. 15, the massager according to the seventh embodiment of the present disclosure is substantially identical to the massager of the aforementioned fifth embodiment, and the identical parts will not be repeated here. The main difference between them lies in that the second transmission assembly 42 of this embodiment includes the second link rod 422 and the third link rod 423 but does not include the first link rod 421. Specifically, as shown in FIG. 15, the second link rod 422 and the third link rod 423 are connected to each other, and a connection point of the second link rod 422 and the third link rod 423 is rotatably connected to the inner wall of the mounting portion 2 corresponding to the mounting cavity 20 to form the rotation center 420. An end of the second link rod 422 extends out of the mounting cavity 20 and is fixedly connected to the first massage member 31. The swinging of the third link rod 423 can drive the first massage member 31 fixed to the end of the second link rod 422 to swing. Additionally, a vibration member 7 may be mounted in the first massage member 31 of this embodiment, enabling the first massage member 31 to provide vibration massage.

Referring to FIG. 16, the massager according to the eighth embodiment of the present disclosure is substantially identical to the massager of the aforementioned first embodiment, and the identical parts will not be repeated here. The main difference between the eighth embodiment and the first embodiment lies in that this embodiment adopts dual drive sources to separately drive the first transmission assembly 41 and the second transmission assembly 42 to move. Specifically, the drive assembly 40 includes the first drive motor 402 and the second drive motor 403. A connection relationship between the first drive motor 402 and the first transmission assembly 41 is substantially the same as that in the first embodiment, except that the first transmission assembly 41 of this embodiment is not connected to the second transmission assembly 42. The output shaft of the second drive motor 403 is arranged with an eccentric protrusion 4030. A structural composition of the second transmission assembly 42 is substantially the same as that in the first embodiment, with the only difference being in the third link rod 423. Specifically, an end of the third link rod 423 away from the rotation center 420 defines a guide groove 4231, and the eccentric protrusion 4030 of the second drive motor 403 is inserted in the guide groove 4231. When the output shaft of the second drive motor 403 rotates, the eccentric protrusion 4030 can slide along a length direction of the guide groove 4231, thereby causing the third link rod 423 to swing around the rotation center 420. In this way, the first link rod 421 and the second link rod 422 can be driven to swing, ultimately causing the first massage member 31 and the second massage member 32 to swing toward or away from each other, achieving the massage purpose of the first massage assembly 3 on the human body. The dual-drive-source driving manner allows the first transmission assembly 41 and the second transmission assembly 42 to move independently, enabling more precise control of the first massage assembly 3 and the second massage assembly 5. Users can choose to activate the first massage assembly 3 or the second massage assembly 5 as needed or activate both the first massage assembly 3 and the second massage assembly 5 simultaneously.

Obviously, the embodiments described above are only a part of the embodiments of the present disclosure, and not all of them. The accompanying drawings give some embodiments of the present disclosure, but do not limit the patentable scope of the disclosure, which may be realized in many different forms. Rather, these embodiments are provided for the purpose of providing a more thorough and comprehensive understanding of the present disclosure. Although the present disclosure has been described in detail with reference to the foregoing embodiments, it is still possible for a person skilled in the art to modify the technical solutions recorded in the foregoing specific embodiments or to make equivalent substitutions for some of the technical features therein. Any equivalent structure made by utilizing the contents of the specification and the accompanying drawings of the present disclosure, directly or indirectly applied in other related technical fields, are all the same within the scope of the patent protection of the present disclosure.

What is claimed is:

1. A massager, comprising:
a main body, defining an accommodation cavity;
a mounting portion, extending outward from a side of the main body;
a first massage assembly, comprising a first massage member and a second massage member spaced apart from the first massage member, wherein the first massage member is mounted on the mounting portion and protrudes outward from the mounting portion, and the second massage member is mounted on the mounting portion and protrudes outward from the mounting portion; and
a drive mechanism, at least partially mounted in the accommodation cavity of the main body, wherein the drive mechanism is drivingly connected to at least one of the first massage member and the second massage member and is configured to drive the at least one of the first massage member and the second massage member to swing toward or away from the other of the first massage member and the second massage member.

2. The massager according to claim 1, wherein a maximum distance between the first massage member and a face of the mounting portion is greater than a maximum distance between the second massage member and a face of the mounting portion.

3. The massager according to claim 1, wherein a mounting cavity is formed in the mounting portion, and the mounting cavity is communicated to the accommodation cavity;
the first massage assembly comprises a massage connecting rod, the massage connecting rod is fixedly connected to at least one of the first massage member and the second massage member, and the massage connecting rod is arranged in the mounting cavity and is drivingly connected to the drive mechanism.

4. The massager according to claim 3, wherein the drive mechanism comprises a drive assembly, a first transmission assembly, and a second transmission assembly;
the second transmission assembly is movably mounted in the mounting cavity and is configured to drive the massage connecting rod and the second massage member;
the first transmission assembly is at least partially mounted in the accommodation cavity, and the first transmission assembly is slidable or rotatable relative to the main body, and is drivingly connectable to the second transmission assembly;
at least a portion of the drive assembly is fixed in the accommodation cavity and is configured to drive the first transmission assembly to slide or rotate, and the second transmission assembly is configured to move when driven by sliding or rotating of the first transmission assembly; or,
the drive assembly is configured to separately drive the first transmission assembly to move and to drive the second transmission assembly to move.

5. The massager according to claim 4, wherein the second transmission assembly comprises a first link rod and a second link rod, an end of the first link rod and an end of the second link rod are connected to each other, and a connection point between the first link rod and the second link rod is rotatably connected to an inner wall of the mounting portion corresponding to the mounting cavity and forms a rotation center;
an end of the first link rod away from the rotation center is arranged with a first guide post, the massage connecting rod is hinged to the inner wall of the mounting portion corresponding to the mounting cavity, the massage connecting rod defines a first guide hole extending along a length direction of the massage connecting rod, and the first guide post is slidable along a length direction of the first guide hole;
the massage connecting rod is fixedly connected to the first massage member, and an end of the second link rod away from the rotation center is fixedly connected to the second massage member;
the first transmission assembly is configured to drive the first link rod and the second link rod to swing around the rotation center, and the first massage member and the second massage member are configured to swing toward or away from each other when driven by swinging of the first link rod and the second link rod around the rotation center.

6. The massager according to claim 5, wherein the second transmission assembly comprises a third link rod, an end of the third link rod is close to the rotation center and is fixedly connected to at least one of the first link rod and the second link rod;
the third link rod defines a second guide hole extending along a length direction of the third link rod;
the first transmission assembly comprises a second guide post engaged in the second guide hole, the second guide post is slidable back and forth along a length direction of the second guide hole, and the first link rod and the second link rod are configured to swing around the rotation center when driven by sliding back and forth of the second guide post along the length direction of the second guide hole.

7. The massager according to claim 4, further comprising a second massage assembly, wherein the second massage assembly is drivingly connected to the first transmission assembly and is arranged on a side of the main body, and the first transmission assembly is configured to drive the second massage assembly to extend/retract or swing relative to the main body.

8. The massager according to claim 7, wherein the first transmission assembly comprises a transmission member, the transmission member is slidably mounted in the accommodation cavity, one end of the transmission member is configured to drive the second transmission assembly, and the other end of the transmission member extends out of the accommodation cavity and is connected to the second massage assembly;
the transmission member is further arranged with a transmission portion drivingly connected to the drive assembly, the drive assembly is configured to drive the transmission member to slide back and forth, and the second massage assembly is configured to extend/retract or swing relative to the main body when driven by sliding back and forth of the transmission member.

9. The massager according to claim 8, wherein the second massage assembly comprises a massage inner shell and a connecting member fixedly connected to the massage inner shell, the connecting member is fixedly connected to the transmission member;
the massage inner shell is configured to slide back and forth when driven by sliding back and forth of the transmission member, and the second massage assembly is configured to extend/retract relative to the main body when driven by sliding back and forth of the massage inner shell.

10. The massager according to claim 8, wherein the second massage assembly comprises a massage inner shell and a connecting member fixedly connected to the massage inner shell, the connecting member comprises a connecting end and defines a guide hole, and the connecting end is hinged to the main body;
the transmission member is arranged with a guide post engaged in the guide hole, and the guide post is slidable back and forth along a length direction of the guide hole;
the massage inner shell is configured to swing back and forth about a rotation axis of the connecting end when driven by sliding back and forth of the transmission member, and the second massage assembly is configured to swing relative to the main body when driven by swinging back and forth of the massage inner shell about a rotation axis of the connecting end.

11. The massager according to claim 4, wherein the drive assembly comprises a drive screw and a guide tube;
the guide tube coaxially sleeves a periphery of the drive screw, and a tube wall of the guide tube defines at least one guide recess, and the at least one guide recess extends along an axial direction of the guide tube;
the first transmission assembly comprises a transmission member slidably mounted in the accommodation cavity, and the transmission member is configured to drive the second transmission assembly and comprises a transmission portion;
the transmission portion comprises a transmission pin, the transmission pin extends through the at least one guide recess, and an end of the transmission pin is inserted into a thread groove of the drive screw;
the transmission pin is configured to slide along a length direction of the at least one guide recess when driven by rotating of the drive screw, and the transmission member is configured to slide when driven by sliding of the transmission pin along the length direction of the at least one guide recess.

12. The massager according to claim 11, wherein the transmission portion comprises a guide protrusion, the guide protrusion is arranged in the at least one guide recess and is slidable along the length direction of the at least one guide recess, and the guide protrusion is configured to restrict a rotation of the transmission member.

13. The massager according to claim 11, wherein the transmission portion comprises a reversing tube, the reversing tube coaxially sleeves an outer wall of the guide tube, and an inner wall of the reversing tube is arranged with a guide protrusion engaged in the at least one guide recess, the guide protrusion is slidable along the length direction of the at least one guide recess, and the guide protrusion is configured to restrict a rotation of the transmission member.

14. The massager according to claim 4, wherein the first transmission assembly comprises a transmission member and a slider, the transmission member is rotatably mounted in the accommodation cavity, and the transmission member comprises a transmission rod and an eccentric rod parallel to each other;
the transmission rod is fixedly connected to a drive shaft of the drive assembly, and the drive assembly is configured to drive the transmission rod to rotate;
the slider is slidably mounted in the mounting cavity, one end of the slider is drivingly connected to the second transmission assembly, the other end of the slider defines a transmission groove, and the slider is slidably connected to the eccentric rod through the transmission groove;
the slider is configured to slide back and forth when driven by rotating of the transmission rod, and the second transmission assembly is configured to move driven by sliding back and forth of the slider;
the massager further comprises a second massage assembly, wherein the second massage assembly comprises a massage inner shell and a connecting shaft sleeve arranged on the massage inner shell;
the first transmission assembly comprises a swing rod, an end of the transmission rod away from the eccentric rod extends out of the accommodation cavity and is fixedly connected to the swing rod, and an axis of the swing rod intersects with an axis of the transmission rod;
the swing rod is rotatably connected to the connecting shaft sleeve, and the swing rod is configured to swing about the axis of the transmission rod when driven by rotating of the transmission rod, and the second massage assembly is configured to swing relative to the main body when driven by swinging of the swing rod about the axis of the transmission rod.

15. The massager according to claim 7, further comprising a soft rubber shell, wherein the soft rubber shell at least covers the first massage member, the second massage member, and the second massage assembly.

16. The massager according to claim 7, further comprising at least one vibration member, wherein at least one vibration member is arranged in at least one of the first massage member, the second massage member, and the second massage assembly.

17. A massager, comprising:
a main body, defining an accommodation cavity;
a mounting portion, extending outward from a side of the main body;
only one first massage member, arranged on the mounting portion and protruding outward from the mounting portion; and
a drive mechanism, at least partially mounted in the accommodation cavity of the main body, wherein the drive mechanism is configured to drive the only one first massage member to swing toward or away from the main body.

18. The massager according to claim 17, wherein the mounting portion defines a mounting cavity, and the mounting cavity is in communication with the accommodation cavity;
the drive mechanism comprises a drive assembly, a first transmission assembly, and a second transmission assembly;
the second transmission assembly is movably mounted in the mounting cavity and is configured to drive the first massage member;
the first transmission assembly is at least partially mounted in the accommodation cavity and is slidable or rotatable relative to the main body, and the first transmission assembly is drivingly connectable to the second transmission assembly;
the drive assembly is at least partially fixed in the accommodation cavity and is configured to drive the first transmission assembly to slide or rotate, and the second transmission assembly is configured to move when driven by sliding or rotating of the first transmission assembly; or,
the drive assembly is configured to separately drive the first transmission assembly to move and to drive the second transmission assembly to move.

19. The massager according to claim 18, wherein the second transmission assembly comprises a first link rod and a third link rod, an end of the first link rod and an end of the third link rod are connected to each other, and a connection point between the first link rod and the third link rod is rotatably connected to an inner wall of the mounting portion corresponding to the mounting cavity and forms a rotation center;
an end of the first link rod away from the rotation center is arranged with a first guide post;
the massager further comprises a massage connecting rod fixedly connected to the first massage member, the massage connecting rod is hinged to the inner wall of the mounting portion corresponding to the mounting cavity, and the massage connecting rod defines a first guide hole extending along a length direction of the massage connecting rod, and the first guide post is slidable along a length direction of the first guide hole;
the third link rod defines a second guide hole extending along a length direction of the third link rod;
the first transmission assembly comprises a second guide post engaged in the second guide hole, the second guide post is slidable back and forth along a length direction of the second guide hole, the first link rod is configured to swing around the rotation center when driven by sliding back and forth of the second guide post along the length direction of the second guide hole, and the first massage member is configured to swing when driven by swinging of the first link rod around the rotation center.

20. The massager according to claim 18, wherein the second transmission assembly comprises a second link rod and a third link rod, an end of the second link rod and an end of the third link rod are connected to each other, and a connection point between the second link rod and the third link rod is rotatably connected to an inner wall of the mounting portion corresponding to the mounting cavity to form a rotation center;
an end of the second link rod away from the rotation center is fixedly connected to the first massage member;
the third link rod defines a second guide hole extending along a length direction of the third link rod;
the first transmission assembly comprises a second guide post engaged in the second guide hole, the second guide post is slidable back and forth along a length direction of the second guide hole, the second link rod is configured to swing around the rotation center when driven by sliding back and forth of the second guide post along the length direction of the second guide hole, and the first massage member is configured to swing when driven by swinging of the second link rod around the rotation center.
